(19) United States
(12) Patent Application Publication
(10) Pub. No.: US 2018/0324390 A1
(43) Pub. Date: Nov. 8, 2018

(54) PERIMETER OPTICAL SECURITY SYSTEM E-FENCE (POSSE) WITH INTEGRATED CLOSED CIRCUIT TELEVISION (CCTV) SYSTEM

(71) Applicant: Innovative Logistics, Inc., Little Rock, AR (US)

(72) Inventors: Dan Hill, Fort Smith, AR (US); Craig Wahlmeier, Alma, AR (US); Dave Leinberger, Tigard, OR (US); Jeff Ferber, Simi Valley, CA (US); Josh Lovan, Greenwood, AR (US)

(21) Appl. No.: 15/971,919

(22) Filed: May 4, 2018

Related U.S. Application Data
(60) Provisional application No. 62/501,913, filed on May 5, 2017.

(51) Int. Cl. H04N 7/18; H04N 7/015; G08B 13/19; H04N 5/33; H04N 9/04; G06K 9/00; H04N 5/247

(52) U.S. Cl. CPC H04N 7/181; H04N 7/015; G08B 13/19; H04N 5/247; H04N 9/04; G06K 9/00362; H04N 5/33

(57) ABSTRACT

Disclosed herein is a Perimeter Optical Security System E-Fence (POSSE) system having a high definition (HD) closed-circuit television (CCTV) system. The HD CCTV system, strategically placed throughout a freight terminal facility, records high definition video data utilizing both fixed and 360° camera hardware. The video is stored on localized servers to be made available for an extended period. There is full video coverage of the dock work area where the majority of freight handling and loading takes place. There are also cameras strategically located in the office and yard locations of the freight terminal facility. Cameras are also strategically placed around the perimeter to provide superior protection. The streaming video can be accessed from both wired and wireless hardware at the local facility as well as remotely.

### CROSS-REFERENCE TO RELATED APPLICATIONS

This application claims priority to U.S. Provisional Application Ser. No. 62/501,913, filed May 5, 2018, the entire contents of which are hereby incorporated by reference in their entirety.

### FIELD OF THE INVENTION

The invention is generally related to security, surveillance and asset tracking systems.

### BACKGROUND

Both freight carriers and their customers desire up-to-date tracking and location of shipments. They also want to prevent theft and unauthorized access to freight during transit. The installation, maintenance, and monitoring of traditional alarm systems are typically outsourced to vendors, and confidence intervals associated with the aforementioned systems are low because they incorporate layers of technology without using visual confirmation. Consequently, false alarms are frequently the result of operator (human) error, debris from wind, animals, and defective equipment. Security managers rely on inadequate police responses to investigate and handle incidents during the closed hours of business. Therefore, a need clearly exists of a security system capable of preventing loss events, reducing costs and false alarms.

### SUMMARY

The present invention provides a Perimeter Optical Security System E-Fence (POSSE) system having a high definition (HD) closed-circuit television (CCTV) system. The HD CCTV system, strategically placed throughout a freight terminal facility, records high definition video data utilizing both fixed and 360° camera hardware. The video is stored on localized servers to be made available for an extended period. There is full video coverage of the dock work area where the majority of freight handling and loading takes place. There are also cameras strategically located in the office and yard locations of the freight terminal facility. Cameras are also strategically placed around the perimeter to provide superior protection. The streaming video can be accessed from both wired and wireless hardware at the local facility as well as remotely.

Further, a HD CCTV surveillance system is activated by thermal heat signature and motion using thermal imaging cameras, thermal radar cameras, and HD color yard cameras to create an event/alarm. The information is received by a video management system and processed through aggregator software. Each alarm is visually verified by a command center who can access the system and live view any event from any location within the HD CCTV network. Aggregator software processes the arming/disarming of the system via electronic keypad at points of egress/ingress. Specifically, the aggregator software detects company-owned equipment and arms/disarms the system as needed to prevent false alarms. The process allows the company to control and manage events by visually investigating each event. Company vehicles equipped with Electronic Logging Devices (ELD's) possess GPS technology, and Geo fencing surrounds each terminal. The system allows the company to control egress/ingress and the arming/disarming of the alarm, thus minimizing unauthorized entry into the facility with little disruption of access by authorized personnel.

The HD CCTV system provides many operational benefits as well. It is used to increase accurate weight and measures as well as authenticate the intensity and validity of workman's compensation claims. Optical Character Recognition (OCR) allows the identification of freight, equipment, and vehicles through the same system. Real Time Location Services (RTLS) tracks the location of freight, equipment and vehicles. An Object Left Behind (OLB) system sends an alert when an item has not moved and may be lost. These three analytics can be overlaid to improve process compliance and efficiency as well as reduce occurrences of loss and damage.

### BRIEF DESCRIPTION OF THE DRAWINGS

FIG. 1 is a block diagram of the overall security, surveillance and asset tracking system.

FIG. 2 is a block diagram of the terminal network including multiple locations and a central command center.

FIG. 3 is a detailed example of installation at a typical terminal.

FIG. 4 is a block diagram of real time location system.

FIG. 5 is a block diagram of object left behind system.

FIG. 6 is a block diagram of perimeter security system.

FIG. 7 is a block diagram of the controlled entry system.

FIG. 8 is a block diagram of optical character recognition system.

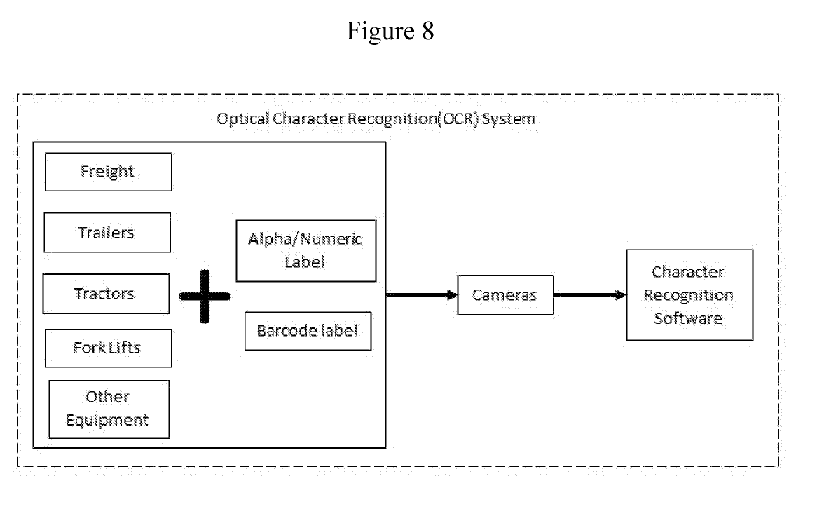

### DETAILED DESCRIPTION

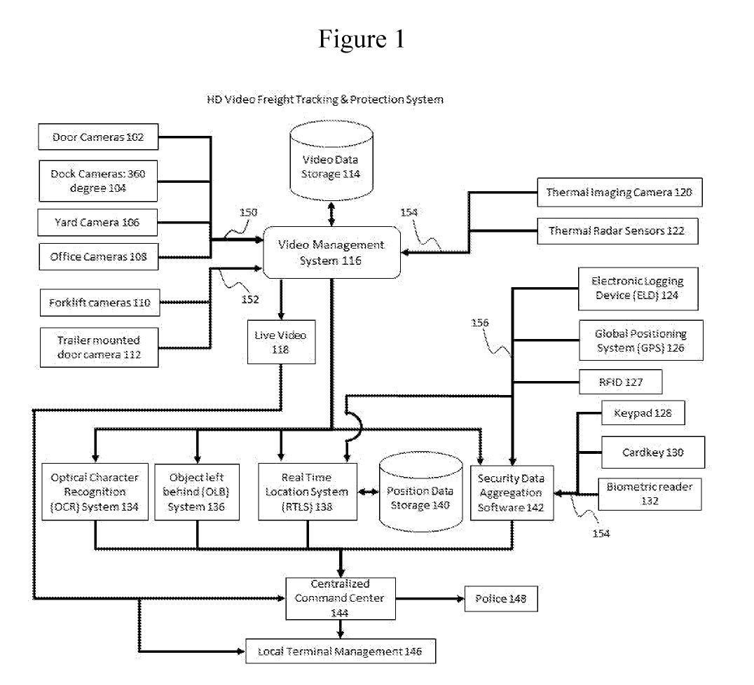

Referring first to FIG. 1, depicted is a block diagram of the security system 100 installed in a LTL freight dock or other similar operation. As shown, the security system 100 comprises a plurality of HD color door cameras 102, 360° color HD dock cameras 104, HD color yard cameras 106, and office cameras 108 for complete video coverage of trailers, dock and yard contained at a LTL shipping facility. These cameras are connected via wire 150 to a video management system 116 contained at the facility. Video is stored by the video management system (VMS) 116 system in video data storage 114 for archive and future use. Video is also available real time for monitoring current activities.

Further, 360° color HD Forklift cameras 110 can be installed on the forklifts to provide additional video coverage. These cameras transmit data wirelessly over wireless network 152 to the video management system 116.

Thermal imaging cameras 120 and/or thermal radar sensors 122 are strategically located around the perimeter of the facility to monitor activity near the perimeter of the facility. They are connected wired or wirelessly to the video management system 116. Thermal cameras 120 and thermal sensors detect 122 and capture the presence, shape and motion of heat producing objects, including people, that may pose a security threat. Thermal cameras 120 also allow for monitoring during darkness, storms, fog, high relative humidity, excessive heat, or similar conditions.

Trailers can also be equipped with door cameras 112 that activate and store images when the door is opened while away from a company-owned facility to capture video of pickup and deliveries. This will also capture any non-conformances during pickup or delivery and capture thefts. Data is sent wirelessly via network 154 to the video management system 116.

Freight that has not moved for an extended period of time may have become misplaced or misrouted. Using the images from the HD CCTV cameras 102-112, the Object Left Behind (OLB) software 136 can detect potentially misplaced freight and alert the local terminal 146 and/or the centralized command center 144 for further investigation and resolution.

Images from the HD CCTV cameras can be analyzed with Optical Character Recognition software 134 to identify characters or barcodes on identification labels. These labels can be placed on objects including but not limited to freight, trailers, tractors, trucks, forklifts, and material handling equipment.

Further, the HD CCTV camera images, along with the real time location software 138, can maintain records and report on the last known position of any object tracked with an alpha numeric label or barcode. Tracked objects include, but are not limited to, freight, trailers, tractors, forklifts, and material handling equipment.

Similarly, RFID tags 127 and sensors can be used to track the location of an object including but not limited to freight, trailers, tractors, forklifts, and material handling equipment.

The location provided from real time location software 138 or the RFID tags 127 will be used to track shipment progress and optimize operations.

Security aggregation software 142 is used to consolidate multiple security/operational functions under one operating platform. The software can coordinate location information, video images, and security threat alerts to a centralized command center 144. The command center 144 distributes alerts and video in response to potential threat identified by the object left behind system 136 and the security aggregation software 142.

Once the command center 144 verifies that a potential threat is an actual threat, there are multiple response options. Responses include, but are not limited to, alerts to local police 148 and/or local terminal employees 146 working for the facility with an alert. Command center 144 can also use an audio speaker 402 to deter an intruder from taking further action.

Authentication to access facilities can be provided by keypad 128, RFID 129, cardkey 130, and/or biometric readers 132 located at entry points. A person's identity is compared to an authorized access list before entry is granted.

Global position system (GPS) 126 integrated with a virtual perimeter crated by a geo-fence can provide authorization for access to facilities. Further, geo-fencing can alert the control center and/ or local operations of the location of a truck, tractor, or trailer that is in an unauthorized location. GPS can also extend the Real time location system (RTLS) 138 to include position of freight while in transit.

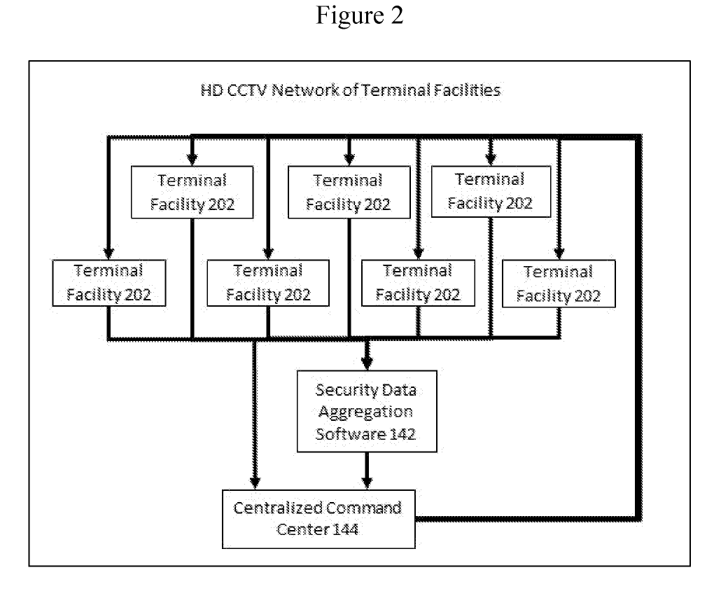

FIG. 2 depicts a block diagram showing how multiple terminal facilities 202, such as LTL hub and spoke facilities, can all be monitored from a single centralized command center 144. Any alarms triggered can be viewed from this centralized location and staff can be dispatched only if the alert is confirmed by the centralized command center 144. This avoids having multiple redundant security personnel at each facility, especially during periods where the facilities are inactive (e.g., early morning or otherwise).

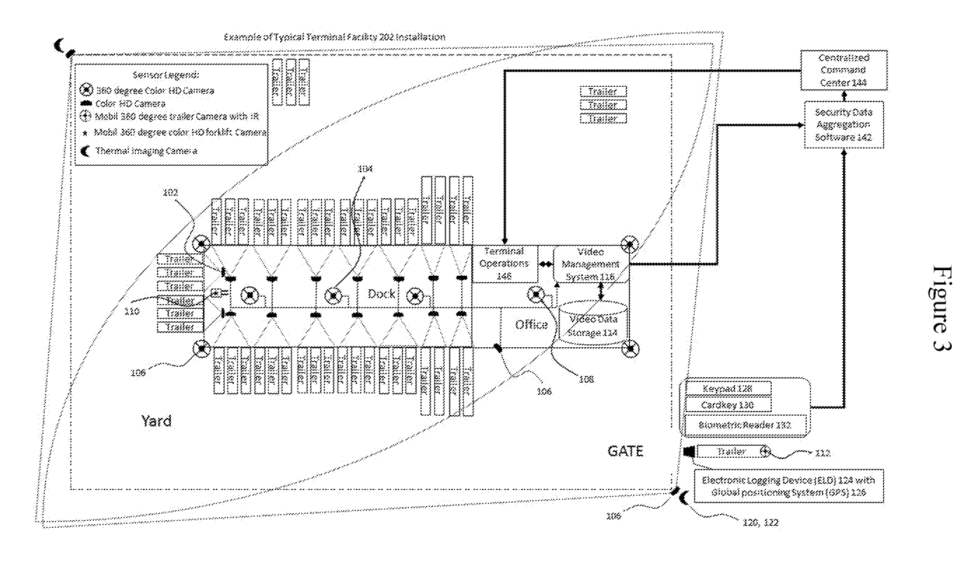

FIG. 3 depicts an overview of an example terminal facility, showing possible placement locations of HD cameras 102-112. As depicted, cameras are strategically placed on the dock and around the yard of the terminal facility 202 in order to provide full visual coverage for surveillance and security monitoring purposes. Use of 360° color HD cameras, in particular, greatly reduces the amount of cameras needed while also reducing blind spots. Further, because the cameras are HD, any captured images can be magnified much more greatly than those in a typical CCTV system. This also enables the HD cameras to be used by OCR system 134 and RTLS 138 because it is much easier to identify barcodes with HD cameras.

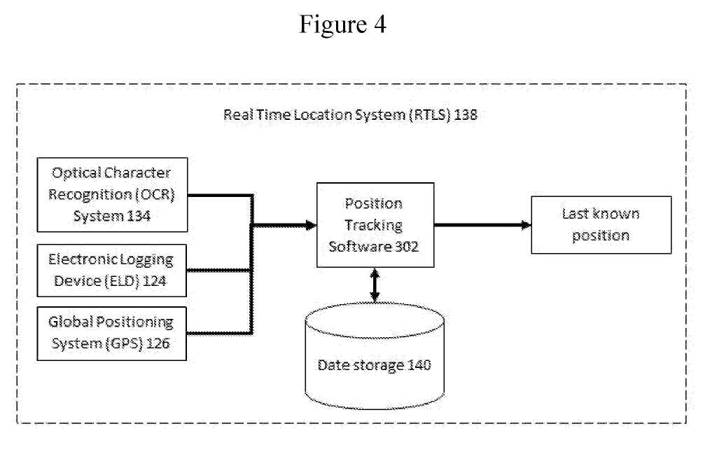

FIG. 4 depicts the various components of the RTLS 138. As shown, in order to track objects, RTLS 138 utilizes a combination of OCR system 134, which reads barcodes placed on objects, electronic logging devices (ELDs) 124, which tracks trailers as they arrive/depart from each facility 202, GPS 126 which can be used to track trailers within each facility 202 (e.g., at the gate, yard, or dock) or to identify the location of the trailers on the road (e.g., to estimate arrival time of each trailer). The information from each of these systems is logged by position tracking software 302 which keeps a record of the last known position of each tracked object in data storage 140. This helps, for example, in locating missing freight because the last known location of the freight is known much more precisely than with other current systems.

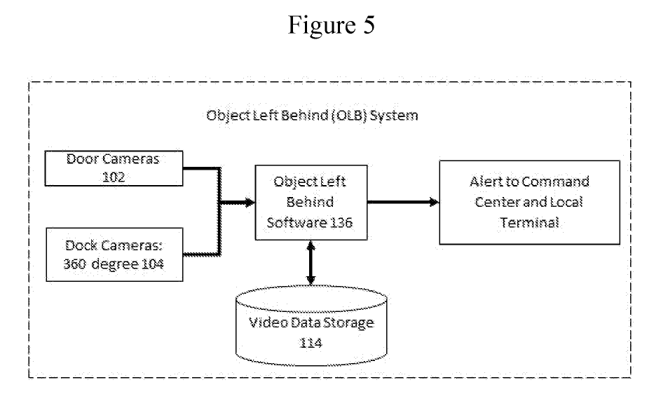

FIG. 5 depicts the various components of OLB system 136. Door cameras 102 and dock cameras 104 are monitored by object left behind software 136. If any freight that is not marked is left in an incorrect location for a specified amount of time or at a wrong location, OLB system alerts the local terminal 146 and/or command center 144 that freight has been left behind. Actions can then be taken by personnel to ensure that the freight is delivered to the intended location. OLB system 136 also may store video/picture of the last known location of the freight which can be used for insurance claims, etc.

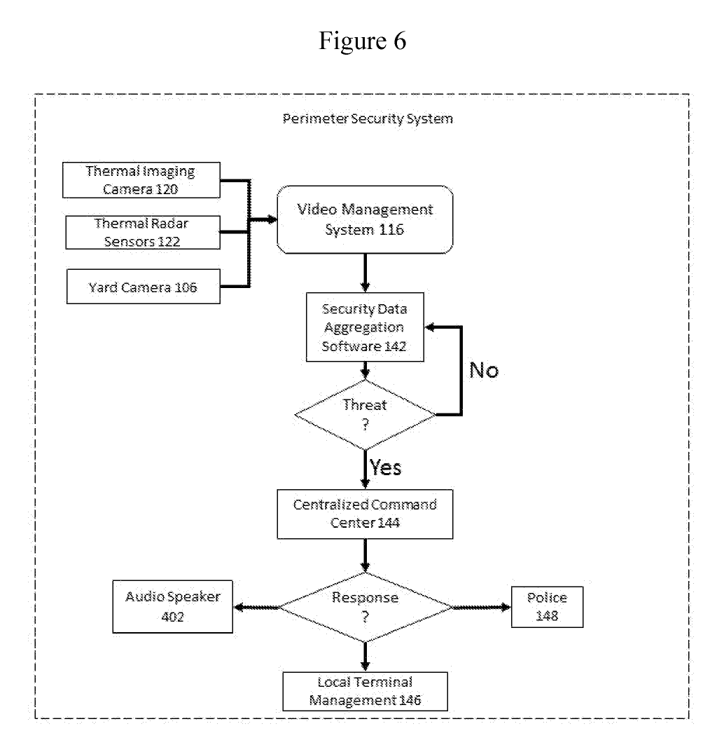

FIG. 6 depicts the interaction of the various components of the perimeter security system which is used to detect intruders and/or unauthorized personnel. The video management system 116 monitors various sources such as thermal imaging camera 120, thermal radar sensors 122, yard camera 106, etc. to detect any movement or thermal signals. Security data aggregation software 142 determines if the movement is a possible threat and alerts command center 144 if a threat is detected. Command center 144 can then utilize video management system 116 to check the video feed to see if a response is warranted. For example, local police 148 can be alerted or the command center 144 can use audio speaker 402 to issue a warning to any intruders or alert local security personnel.

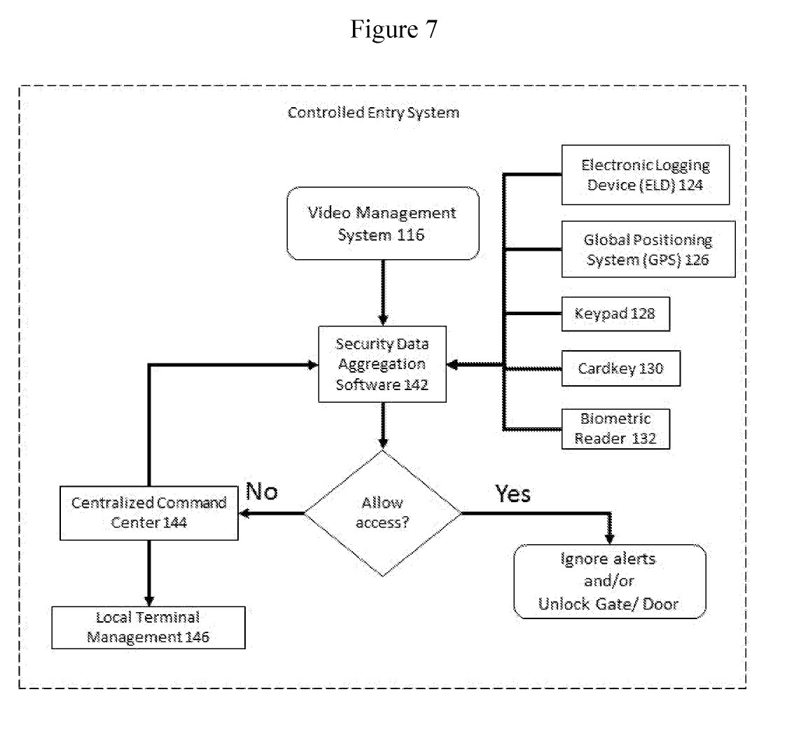

FIG. 7 depicts the interaction of the various components utilized by the controlled entry system which is used to provide access to authorized users at each facility 202. As shown, security data aggregation software 142 monitors the use of ELDs 124, GPS 126, keypads 128, cardkeys 130, and/or biometric readers 132 at each facility 202. As a check, security data aggregation software 142 also utilizes the video management system 116 as a backup. For example, if it is detected that a keypad 128 is being used, security data aggregation software 142 may utilize finger print recognition software as a backup to verify that the correct user is utilizing the keypad 128. In particular, security data aggregation software 142 decides whether or not to grant access to different areas of facility 202. If access is not granted for whatever reason, security data aggregation software 142 can alert command center 144 or local terminal 146 which can then investigate further.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A security system comprising:
a plurality of high definition (HD) closed-circuit television (CCTV) cameras placed throughout a facility;
a central monitoring station for monitoring video feeds from the HD CCTV cameras;
a video data storage system for storing video from the video feeds;
a real time location system (RTLS) for monitoring the video feeds;
an object left behind (OLB) system for monitoring the video feeds;
an optical character recognition (OCR) system for monitoring the video feeds; and
an alerting system for producing alarms based upon detection of events by the RTLS, the OLB system, and the OCR system.

2. The security system according to claim 1, wherein the CCTV cameras comprise 360° color HD cameras, color HD cameras, and thermal imaging cameras.

3. The security system according to claim 2, wherein the thermal imaging cameras are spaced around a perimeter of the facility; and
if a thermal signature representing a human is detected, an alarm is provided to the central monitoring station.

4. The security system according to claim 3, wherein, before the alarm is provided, a color HD camera in a vicinity of the thermal signature is analyzed to detect the human as verification for the alarm.

5. The security system according to claim 1, wherein the CCTV cameras comprise a plurality of HD cameras coupled to forklifts in the facility.

6. The security system according to claim 1, wherein the OCR system detects tags in the video feeds; and
if a tag from the tags is stationary for a predetermined period of time, the OLB system generates an alarm for the central monitoring station.

7. The security system according to claim 1, further comprising:
a user authentication system;
wherein, if unauthorized credentials are used with the verification system, a HD CCTV camera in a vicinity of the verification system is activated and video of the user authentication system is recorded for review at the central monitoring station.

8. The security system according to claim 7, wherein the user authentication system comprises a keypad and a cardkey reader.

9. The security system according to claim 8, wherein the keypad and the cardkey reader are both required to provide authorized credentials for the facility.

10. The security system according to claim 1, wherein the facility comprises:
a plurality of thermal radar sensors; and
a plurality of thermal imaging cameras.

11. The security system according to claim 10, wherein generation of an alert by the alerting system requires (a) a positive identification from a thermal radar sensor and (b) a positive identification from a thermal imaging camera in a vicinity of the thermal radar sensor.
